(19) United States
(12) Patent Application Publication
(10) Pub. No.: US 2026/0332067 A1
(43) Pub. Date: Oct. 22, 2026

(54) METHOD FOR MONITORING AN ELECTRIC MACHINE

(71) Applicant: Innomotics GmbH, 90441 Nürnberg (DE)

(72) Inventors: JULIA HOFMOCKEL, Nürnberg (DE); SASCHA DUMKE, Nürnberg (DE); ALIRIO FAZIO JUNIOR, São Paulo, São Paulo (BR); JENS WINTER, Hessisch Lichtenau (DE)

(73) Assignee: Innomotics GmbH, 90441 Nürnberg (DE)

(21) Appl. No.: 19/116,663

(22) PCT Filed: Sep. 29, 2023
(86) PCT No.: PCT/EP2023/077112

§ 371 Date: Mar. 28, 2025

(30) Foreign Application Priority Data
Sep. 30, 2022 (EP) 22198924.7

(51) Int. Cl. H02P 6/12; H02P 6/34

(52) U.S. Cl. CPC H02P 6/12; H02P 6/34

(57) ABSTRACT

A method for monitoring an electric machine is carried out for recurring operating states of the electric machine. Real data in relation to control of the electric machine are monitored against expected data, Deviations between the real data and the expected data are added over time, and the deviations are used to classify the behavior of the control. The classification of the control is monitored over time, and the expected data are changed on the basis of the monitoring of the classification.

The invention relates to a method for monitoring an electric machine. An electric machine is, for example, a dynamoelectric machine, such as a motor or a generator, for example. An electric machine is, for example, a drive, which has a current converter and a dynamoelectric machine, such as a motor in particular. The current converter itself can also be referred to as an electric machine. Electrically driven machines such as pumps, fans or compressors can also be referred to as electric machines. The invention relates in particular to a method for automated identification of rotational speed control deviations in drive converters, which are also subsumed under the current converters, for standard applications such as in the case of pumps, fans or compressors.

In particular, the electric machine is controlled by means of a closed-loop control. There is a deterministic relationship between the characteristic variables of setpoint rotational speed and obtained motor rotational speed. In many instances, the two variables match in a normal case. However, additional parameters, such as a minimum rotational speed or the avoidance of critical rotational speeds, influence the relationship between the characteristic variables. This means that there is no generally valid rule and machine-specific differences are produced. Particularly if the torque limits are reached, it can happen, for example, that the setpoint rotational speed is not reached. States, events or developments of this kind are to be identified or monitored. The setpoint rotational speeds and actual rotational speeds of the electric machine can be monitored manually by experts over longer periods of time. Taking a time series into consideration, for example at irregular time intervals, is used in particular to classify the current health state of the electric machine. This makes it possible to monitor the electric machine and/or the application of the electric machine.

One object of the invention is to improve a monitoring of an electric machine.

An achievement of the object is produced as claimed in a method in accordance with claim 1. A further achievement of the object is produced in accordance with one of claims 2 to 7, for example.

In a method for monitoring an electric machine, wherein the monitoring in particular takes place for recurring operating states of the electric machine, data relating to rotational speed is used for the monitoring, wherein a linear regression model is trained on the basis of training data, wherein a total error sum is calculated, wherein if the total error sum exceeds a limit value, an error is identified and/or a classification takes place and/or a new model is trained. In particular, a classification takes place. In particular, the classification has two states, such as the normal state and the abnormal state, for example. If the classification always has the abnormal state over a predefined or predefinable time, then a new model is trained. Therefore, if the ascertained total error sum exceeds the limit value, for example, then an abnormal behavior is identified. A classification as abnormal therefore takes place. If the limit value is not exceeded, then a classification as normal takes place. If the classification is abnormal for a longer period of time, then a new model is trained. A new model is therefore trained if the error or if the total error sum is present persistently, i.e. the total error sum is exceeded persistently. In particular, it is possible to set the duration, upon which exceeding is present persistently. In turn, the new model is based in particular on a linear regression model. In particular, it is possible to set the limit value that is used for the total error sum. The duration can relate to seconds, minutes or hours, for example, and in particular can be set by a user. The duration that is set or used depends, in particular, upon the application case. In particular, the limit value can also be adjusted by a user. Thus, the method can be adjusted for specific machines, for example. In particular, this makes it possible to identify abnormal operating states of machines by means of a general approach for monitoring. Through the use of a total error sum and the monitoring thereof by means of a limit value, it is possible to adjust the monitoring of a machine again and again, i.e. to adapt it on a recurring basis, i.e. in particular even if boundary conditions are to change. In particular, this can produce an endless loop of recurring adaptations for the monitoring. Through the use of the linear regression model in conjunction with the formation of a total error sum, it is possible to achieve an automated identification of an error behavior of the algorithm in a reliable manner.

In one embodiment of the method, the error that is used for the summation is set to zero for irrelevant time points.

In one embodiment of the method, a weighting is used during the calculation of the total error sum. In particular, the weighting relates to a forgetting factor. The forgetting factor weights errors against their age. The older an error is, the smaller its weighting. Thus, past errors are not perpetuated persistently.

In a method for monitoring an electric machine, the monitoring takes place for recurring operating states of the dynamoelectric machine, wherein a monitoring of real data of a closed-loop control of the dynamoelectric machine with expected data takes place, wherein deviations of the real data and the expected data are accumulated as a function of the time, wherein a classification of the behavior of the closed-loop control is performed by means of the deviations, wherein the classification of the closed-loop control is monitored over time, wherein the expected data is changed as a function of the monitoring of the classification.

Recurring operating states are, for example, the starting up or slowing down of a motor. A recurring operating state can also be an operating state of an installation or can depend upon this operating state of the installation, wherein the electric machine is located in the installation.

The data used for monitoring is, in particular, rotational speed data, which can also be referred to as characteristic variables. For example, in a motor there is a deterministic relationship between the characteristic variables of setpoint rotational speed and obtained motor rotational speed. In many instances, the two variables match in a normal case. However, additional parameters, such as a minimum rotational speed or the avoidance of critical rotational speeds, influence the relationship between the characteristic variables. This means that there is no generally valid rule and machine-specific differences are produced. Particularly if the torque limits are reached, it can happen that the setpoint rotational speed is not reached.

Until now, the setpoint or actual rotational speed have had to be monitored manually by experts over long periods of time. Taking into consideration the time series at irregular intervals had been used to classify the current health state. However, this assessment presupposes expert knowledge, as in many operating states a deviation of the signals from one another is not relevant. This is, for example, caused by starting up or shutting down the motor, load change, process-related rotational speed setpoint value changes, etc. Setting parameters of the converter, such as a minimum rotational speed or the avoidance of critical rotational speeds, also includes influencing factors that influence the obtained motor rotational speed. At the present time, these parameters are read out manually and consulted by experts for assessment purposes. A problem of this kind can be solved by the method described. This is accomplished, in particular, by an automated comparison of the characteristic variables or a classification into normal or abnormal behavior. An automatic data preprocessing and a data-driven approach make it possible to determine the normal state to be expected and can be used to determine anomalies automatically and within a short time. A change (for example, in the process parameters) is also identified in an automated manner on the basis of the data. The error status is adjusted accordingly. A continuous comparison, in particular of the setpoint/actual motor rotational speed, is thus made possible, with the automated consideration of the operating state and the machine-specific dependencies. An anomaly identification which builds thereon completes the overall system for monitoring the characteristic variables. In particular, data relating to rotational speed is used as data during the monitoring.

Expected data is, in particular, data that is generated by a model. The model can be used to model at least a part of the electric machine. The electric machine can be simulated, i.e. modeled, at least in part or as a whole. In particular, a closed-loop control of the electric machine is modeled, so that a behavior of the electric machine can be simulated as a whole or in part. In this context, actual values of the electric machine are simulated in particular. This includes, for example, a rotational speed, a torque, a temperature and/or values (data) dependent thereon, etc. Values are produced, in particular, from signals of the electric machine. In particular, signals are generated by sensors.

These make it possible to monitor an electric machine. It can thus be made possible to automate a monitoring of an electric machine with closed-loop rotational speed control, in particular. The monitoring takes place, in particular, for or in the event of non-dynamic applications of the electric machine. One example for the use of the described monitoring in the event of a non-dynamic application is an application in which a setpoint rotational speed or an actual rotational speed of the electric machine is constant.

The method for monitoring takes place, in particular, with the consideration of at least one of the following boundary conditions or criteria:
identifying process-related changes in rotational speed and differentiating from an error behavior (adaptation of the error identification to normal process-related changes),
identifying control system-related changes in rotational speed and differentiating from an error behavior and/or
identifying parameter-related changes in rotational speed and differentiating from an error behavior.

This can be achieved by a systematic adaptation of the identification, without active knowledge of the changes mentioned above.

Otherwise, these criteria can only be filtered in elaborate manual data aggregations, in order to achieve an identification of the erroneous closed-loop control. The automatic dynamic adaptation of the identification algorithm to changed boundary conditions without adjustment of parameters or long learning phases, with the consideration of a generic approach (as described here) and with the aid of a numerical model of the electric machine, i.e. in particular of the motor, the converter and/or the load machine, is an example of a basis of the error identification described.

The monitoring of the electric machine can also relate to or include an assessment of the electric machine. An assessment of this kind makes it possible to replace expert knowledge. Operating states can be taken into consideration. In some operating states, a deviation of the values or signals (data) from one another, i.e. in particular the deviation of an actual value from a setpoint value, may not be relevant. This is, for example, caused by a starting up or shutting down of the motor, a load change, process-related rotational speed setpoint value changes, etc. Setting parameters of the converter, such as a minimum rotational speed or the avoidance of critical rotational speeds, also includes, for example, influencing factors that influence the obtained motor rotational speed. These parameters can be either read out manually and consulted by experts for assessment purposes, or integrated into the monitoring in an automated manner. A further option is setting static limit values, which can cause an alarm message for the status “at torque limits”. This makes it possible to monitor the state of torque limits, and additionally enables a comparison of the characteristic variables to take place in an automated manner. Thus, a manual, visual observation is no longer necessary. Thus, for example, specific expert knowledge is also no longer necessary, which could presuppose a time-intensive deep data aggregation. An analysis is associated with high outlay in terms of personnel. Due to the automated monitoring, even over very long periods of time of the operation of the electric machine, these no longer have to be observed manually. During operation of the electric machine, while it is being monitored over longer periods of time, data is monitored, wherein this takes place in particular with the consideration of exclusion criteria or events. are assessed. Exclusion criteria or events are, in particular, produced from operating states and, in particular, are also taken into consideration automatically.

In one embodiment of the method, the data is or relates to a rotational speed and/or a torque of the electric machine.

In one embodiment of the method, the accumulation over time relates to minutes, hours, days and/or months. Thus, longer periods of time of the data monitoring are produced. These periods of time differ from short periods of time, such as times that occur during a closed-loop control, for example. In electric machines, closed-loop controllers frequently work in short periods of time, such as seconds or milliseconds.

In one embodiment of the method, a model that relates to the electric machine is used to generate the expected data. For example, the model can also relate to the closed-loop control of the electric machine and the electric machine as a whole or in part.

In one embodiment of the method, a new model is generated as a function of the classification. During the classification, or due to it, it is therefore identified, for example, whether the model is still correct. If it is still correct, then it is used further. If it is no longer correct, then a new model is generated. This takes place, in particular, through retraining of the model, or generating a new model and training it.

In one embodiment of the method, the model and/or the new model is/are trained. Thus, following the training, the model or the new model is trained. This makes it possible to adjust a model to a particular environmental situation for the electric machine.

Through at least one of the methods described, a long-term comparison of a demanded and obtained motor rotational speed is possible in particular. An automated comparison, for example of the characteristic variables, and a classification into normal or abnormal behavior, take place in particular.

An automatic data preprocessing and a data-driven approach make it possible to determine the normal state to be expected and can be used to determine anomalies automatically and within a short time. A change in boundary conditions (for example, in the process parameters) can also be identified in an automated manner on the basis of the data. An error status is adjusted accordingly, for example.

In accordance with the method, a continuous comparison, for example of the setpoint/actual motor rotational speed, is made possible, namely with the automated consideration of the operating state and/or the machine-specific dependencies. The anomaly identification which builds thereon completes the overall system for monitoring the characteristic variables.

In one embodiment of the method, automatic data preparation is performed. The automated data preprocessing is used, in particular, to increase the accuracy. It reduces the number of erroneously identified anomalies. Characteristic variables which deviate from one another cannot always imply true problems, but rather emerge due to measurement inaccuracies or non-significant operating states:
Smooth signal: The setpoint/actual signals are smoothed by means of rolling medians:

x(t)=mnediant([xₜ₋₂,xₜ₋₁,xₜ,xₜ₊₁,xₜ₊₂])
Consider sign: The sign of the obtained motor rotational speed is adjusted to that of the demanded rotational speed:

Spd Ref=SpdRef*sign(MtrSpd)
Determine relevance: As a further step, the relevance of a time stamp t is determined. Measurement values that are separated from the next off state by particular periods of time are considered to be irrelevant. Periods of time in which the machine is not running (including start-up and shut-down times, for example) are not included in the consideration. Points in time in which the obtained rotational speed lies below the minimum limits specified in the converter are also considered to be irrelevant:

$$t = \{ \begin{matrix}relevant , & t stationary and SpdRef ( t ) > minSpdRef \\ irrelevant , & else\end{matrix}$$

These steps are performed in an automated manner, so that an expert can concentrate directly on the significant events and is not misled by false messages. The inclusion of the additional measurement values brings into consideration the context that relates to the operating state and a demanded rotational speed and enables an automated comparison of the relevant points in time.

In one embodiment of the method, an automatic training phase is performed. In the automatic training phase, the collected machine data is used in order to train a reference model, which describes the normal relationship between demanded (SpdDmd) and obtained (SpdRef) motor rotational speed.
The data C of the respective machine is used to determine the relationship between the characteristic variables. The irrelevant measurement points marked in step 1 are filtered and ignored here:

Training data={G|t relevant}
On the basis of the training data, a linear regression model is trained, which describes the relationship:

SpdRef′=b*SpdDmd+α

In one embodiment of the method, an automated identification or classification is performed. This takes place, in particular, in an application phase of the monitoring.

In the application, the model learned in the above step is applied to new data and a total error sum is calculated. For a demanded rotational speed, the reference model delivers the obtained motor rotational speed normally to be expected. This is compared with the actual value, which leads to the error:

Error(t)=|SpdRef(t)−SpdRef′(t)|
For irrelevant points in time from step 1, the error is set to 0:

Error(t)=0,∀t irrelevant
To classify a time stamp as normal or abnormal, the error is added to a total error sum Σ, Greater deviations are more heavily weighted, as the error sum increases more rapidly when deviations are more pronounced. Due to a forgetting factor (α<1), the total error sum Σ decreases again over time and past errors are not carried further persistently:

Σ(t)=α*Σ(t−1)+error(t)
If the error sum exceeds a settable limit value, then the point in time is classified as abnormal:

$$t = \{ \begin{matrix}normal , & \sum ( t ) \leq limit value \\ abnormal , & else\end{matrix}$$

The error sum is limited to a maximum n, whereby a correction is ascertained in a timely manner. Due to the forgetting factor, the error sum reduces during normal operation, and after sufficiently normal measurement values the status is automatically set to normal.

Σ(t)=min([Σ(t),m])

By means of one the methods described, for example, an automated comparison of demanded and obtained motor rotational speed is possible without any manual effort. This is made possible by a data-based training of the normal state and the error resulting therefrom for new data points. In conjunction with the data preparation and the consideration of the total error sum, it is possible to identify the genuine anomalies, while irrelevant outliers are ignored. A further advantage is that the transitions between training and application phase can take place in a completely automated manner. Training takes place until the model parameters converge, whereby there is no need for manual preselection of good/bad data. During the application, it is reviewed on an ongoing basis, in particular, whether the reference model is still current and a new training procedure is initiated in an automated manner. The expected relationship between the signals is trained on the basis of machine data, whereby the detailed consideration of the converter parameters is omitted. An expert model created in an elaborate manner is replaced by a simple data model. This means simple scalability and applicability to any given assets, i.e. to different electric machines.

The features of the individual claimed or described subject matters and methods can be readily combined with one another. The invention will now be presented and explained in greater detail with reference to the figures. The features shown in the figures can be combined by the person skilled in the art to form new embodiments without departing from the invention. In the figures:

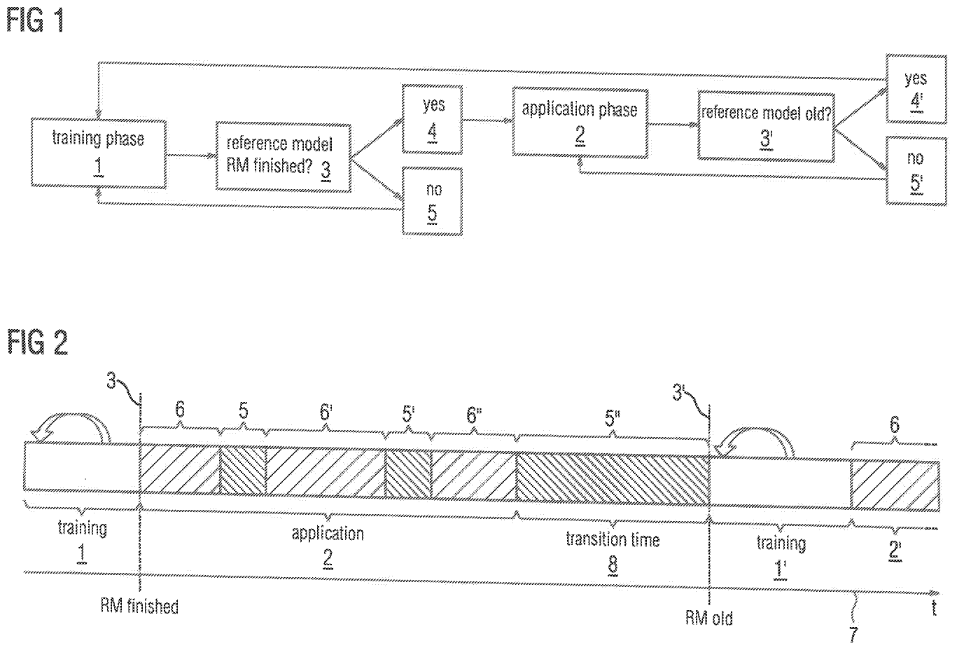

FIG. 1 shows the use of models, and

FIG. 2 shows training phases and application phases.

The representation according to FIG. 1 shows the use of models, in particular the interaction between automated training and application phases.

The representation according to FIG. 2 shows training phases and application phases together with a transition time over a timeline 7. Said timeline shows the training 1, 1′ and the application of the reference model (RM) in the timeline 7. After a phase for training 1′ the reference model (model), this finishes and is applied in the application phase 2. The application phase 2 has normal phases 6, 6′, 6″, which are unremarkable, and phases which are not normal, i.e. which represent an anomaly. These phases with the anomaly are the anomaly phases 5, 5′, 5″. Through at least one of the anomaly phases, it is possible to identify that the model (RM) is outdated. This results in a transition time 8, in which the model is outdated. This is followed by a new training 1′, with a subsequent application 2′ of the model with a new first normal phase 6 in the application 2′.

To this end, the representation according to FIG. 1 shows the sequence in a block diagram. In particular, an amount of machine data is used in order to train a reference model (model), which describes a normal state, in a training phase 1. The preprocessed, relevant data is used for this purpose. The training takes place until it is finished. To this end, the model is queried 3 iteratively, or in a loop, and a response 4, 5 is ascertained. When the model is finished, then an application phase 2 follows. In this context, it is queried iteratively, or in a loop, whether the model is old, i.e. outdated. This produces the responses 4′ for yes and 5′ for no, which lead to the corresponding subsequent loop. The response, regarding whether an outdated model is present, is produced from an evaluation of the identified anomalies. During ongoing operation, the trained model is thus used in the application phase 2, in order to classify the points in time as normal or abnormal. An error resulting from the reference model, for example, is added to this to form a total error sum and is assessed on the basis of a fixed limit value. The current time stamp is classified as normal or abnormal. The interaction between the two phases is illustrated by the representations according to FIG. 1 and FIG. 2. If data, in particular from the past, is present, then a training phase can begin. As soon as the reference model converges, i.e. as soon as the model parameters no longer change significantly, then it is considered fully trained and can be used for new data points in the application phase. Within the learning phase, the points in time are classified as normal or abnormal. Unconventional states are thereby identified and reported to a user. If the unconventional state continues, then a fundamental change to the system or operation can be assumed. The originally trained “normal state” no longer covers the reality and has to be re-trained. A transition time (for example, a week or a month) ensures that the change is made visible as an anomaly. It is possible to respond to this on the basis of the method described. In response, the reference model can be renewed in an autonomous, i.e. automated manner, whereupon a new normal state is defined.

1.-7. (canceled)

8. A method for monitoring an electric machine, the method comprising:
monitoring the electric machine for recurring operating states of the electric machine using data relating to rotational speed of the electric machine;
training a linear regression model based on training data;
calculating a total error sum;
identifying an error when the total error sum exceeds a limit value;
training a new model when the error or when a total error sum is present persistently; and/or
performing a classification, the classification having two states, a normal state and an abnormal state;
training a new model when the classification always has the abnormal state over a predefined or predefinable time.

9. The of claim 8, further comprising setting a duration, upon which exceeding is present persistently.

10. The method of claim 8, wherein the new model in turn is based on a linear regression model.

11. The method of claim 8, further comprising setting the limit value that is used for the total error sum.

12. The method of claim 9, wherein the duration relates to seconds, minutes or hours and depends upon an application case.

13. The method of claim 8, further comprising:
monitoring real data of a closed-loop control of the electric machine with expected data, the data relating to rotational speed;
accumulating deviations of the real data and the expected data as a function of the time;
performing a classification of the behavior of the closed-loop control by the deviations;
monitoring the classification of the closed-loop control over time; and
changing the expected data as a function of the monitoring of the classification.

14. The method of claim 8, wherein the data relates to a rotational speed and/or a moment of the electric machine.

15. The method of claim 13, wherein the accumulation over time relates to minutes, hours, days and/or months.

16. The method of claim 13, further comprising using a model that relates to the electric machine to generate the expected data.

17. The method of claim 16, further comprising generating a new model as a function of the classification.

18. The method of claim 17, wherein the model and/or the new model are trained and/or become trained.
